(19) United States
(12) Patent Application Publication
(10) Pub. No.: US 2009/0226621 A1
(43) Pub. Date: Sep. 10, 2009

(54) COATING TREATMENT METHOD, COMPUTER-READABLE STORAGE MEDIUM, AND COATING TREATMENT APPARATUS

(75) Inventors: Mitsuo YAMASHITA, Taiwan (CN); Tomohiro ISEKI, Koshi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/395,914

(22) Filed: Mar. 2, 2009

(30) Foreign Application Priority Data
Mar. 4, 2008 (JP) 2008-052881

(51) Int. Cl. B05D 3/12; B05C 11/00

(52) U.S. Cl. 427/346; 118/665

(57) ABSTRACT

The present invention is a coating treatment method of applying a water-soluble coating solution onto a substrate, including: a first step of supplying pure water to a central portion of the substrate in a manner that the pure water does not diffuse over an entire surface of the substrate; a second step of subsequently supplying the water-soluble coating solution to a central portion of the pure water on the substrate to form a mixed layer of the coating solution and the pure water, under the coating solution; and a third step of subsequently diffusing the mixed layer over the substrate to diffuse the coating solution over the entire surface of the substrate.

### BACKGROUND OF THE INVENTION

1. Field of the Invention

The present invention relates to a coating treatment method, a computer-readable storage medium, and a coating treatment apparatus each for applying a water-soluble coating solution onto a substrate such as a semiconductor wafer or the like.

2. Description of the Related Art

In a photolithography process in a manufacturing process of a semiconductor device, for example, a resist coating treatment of applying a resist solution onto a semiconductor wafer (hereinafter, referred to as a “wafer”) to form a resist film, exposure processing of exposing a predetermined pattern to light on the resist film, a developing treatment of developing the exposed resist film and so on are performed in sequence to form a predetermined resist pattern on the wafer.

In various coating treatments such as the above-described resist coating treatment, a so-called spin coating method is frequently used in which a coating solution is supplied from a nozzle to a central portion of the rotated wafer and the centrifugal force is utilized to diffuse the coating solution over the wafer to thereby apply the coating solution on the wafer. In this spin coating method, a method in which, for example, a solvent for the coating solution is supplied onto the wafer to prewet the wafer, the rotation of the wafer is then accelerated to a first rotation number, the coating solution is then supplied to the rotated wafer, subsequently the rotation of the wafer is temporarily decelerated to a second rotation number to adjust the film thickness of the coating solution on the wafer, and the rotation of the wafer is then accelerated again to a third rotation number to thereby spin-dry the coating solution on the wafer, has been proposed as a method of uniformly applying a small mount of coating solution (Japanese Patent No. 3330324).

### SUMMARY OF THE INVENTION

When, for example, the water-soluble coating solution is applied to a wafer using the above-described spin coating method, for example, pure water is supplied onto the wafer as the solvent for the coating solution. The pure water, however, has a large contact angle, so that the pure water diffuses over the wafer immediately after it is supplied. Since the pure water has poor “wettability” as described above, some portions could be remained unwet with the pure water even after the prewetting. In this case, even if the coating solution is subsequently supplied onto the wafer, the flowability of the coating solution is not improved. Accordingly, supply of a large amount of coating solution could be required to uniformly apply the coating solution within the wafer.

The present invention has been developed in consideration of the above point, and its object is to reduce the supply amount of a coating solution while uniformly applying the coating solution within a substrate, when a water-soluble coating solution is applied over the substrate.

To achieve the above object, the present invention is a coating treatment method of applying a water-soluble coating solution onto a substrate, including: a first step of supplying pure water to a central portion of the substrate in a manner that the pure water does not diffuse over an entire surface of the substrate; a second step of subsequently supplying the water-soluble coating solution to a central portion of the pure water on the substrate to form a mixed layer of the coating solution and the pure water, under the coating solution; and a third step of subsequently diffusing the mixed layer over the substrate to diffuse the coating solution over the entire surface of the substrate.

In the present invention, the formed mixed layer is smaller in contact angle than the pure water and therefore becomes better in wettability. As a result, the mixed layer then diffuses over the substrate, and the coating solution is led by the mixed layer and thereby becomes easy to diffuse over the substrate. Accordingly, the coating solution can be uniformly applied within the substrate, and the supply amount of the coating solution can also be reduced.

According to another aspect, the present invention is a computer-readable storage medium storing a program running on a computer of a control unit which controls a coating treatment apparatus in order to cause the coating treatment apparatus to execute a coating treatment method.

According to still another aspect, the present invention is a coating treatment apparatus for applying a water-soluble coating solution onto a substrate, including: a coating solution nozzle for supplying the coating solution to the substrate at a predetermined timing; a pure water nozzle for supplying pure water to the substrate at a predetermined timing; and a control unit. The control unit controls operations of at least the coating solution nozzle and the pure water nozzle to execute a first step of supplying pure water to a central portion of the substrate by the pure water nozzle in a manner that the pure water does not diffuse over an entire surface of the substrate; a second step of subsequently supplying the water-soluble coating solution to a central portion of the pure water on the substrate by the coating solution nozzle to form a mixed layer of the coating solution and the pure water, under the coating solution; and a third step of subsequently diffusing the mixed layer over the substrate to diffuse the coating solution over the entire surface of the substrate.

### BRIEF DESCRIPTION OF THE DRAWINGS

FIG. 1 is a longitudinal sectional view showing the outline of a configuration of a coating treatment apparatus according to an embodiment;

FIG. 2 is a transverse sectional view showing the outline of the coating treatment apparatus;

FIG. 3 is a flowchart showing main steps of a coating treatment process;

FIG. 4 is a graph showing the numbers of rotations of a wafer and supply timings of a coating solution and pure water in the steps of the coating treatment process;

FIG. 5 is an explanatory view schematically showing a state of a solution film on the wafer in each of the steps of the coating treatment process; and

FIG. 6 is a graph showing a measurement result of the film thickness of the coating film formed on the wafer after the coating treatment in an example.

### DETAILED DESCRIPTION OF THE INVENTION

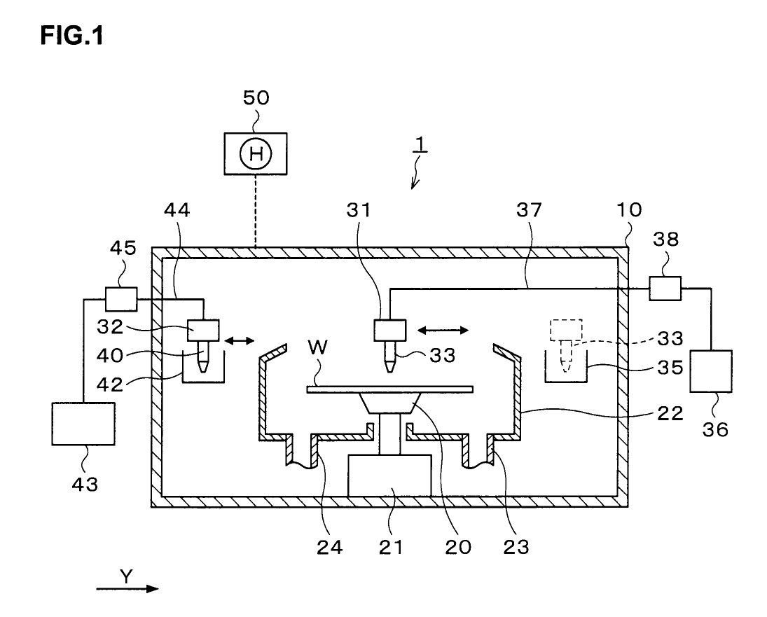

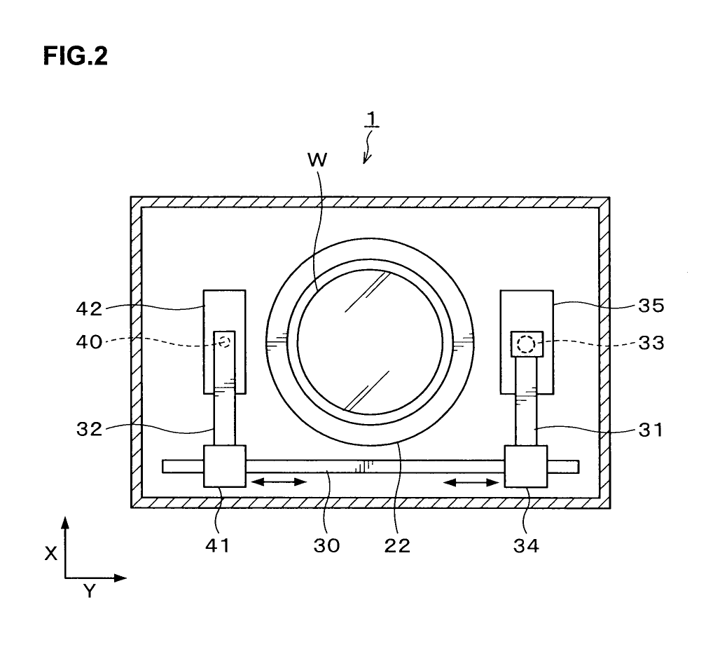

Hereinafter, a preferred embodiment of the present invention will be described. FIG. 1 is a longitudinal sectional view showing the outline of a configuration of a coating treatment apparatus 1 according to this embodiment, and FIG. 2 is a transverse sectional view showing the outline of the configuration of the coating treatment apparatus 1. Note that in this embodiment, an anti-reflection film liquid material to be applied onto a wafer W on which a resist film has been formed is used as a coating solution in order to form an anti-reflection film for preventing reflection of light at exposure processing. The anti-reflection film liquid material as the coating solution contains, for example, a water-soluble resin and a low-molecular organic compound such as carboxylic acid or sulfonic acid.

The coating treatment apparatus 1 has a treatment container 10 as shown in FIG. 1, and a spin chuck 20 as a rotating and holding member which holds and rotates the wafer W thereon is provided at a central portion in the treatment container 10. The spin chuck 20 has a horizontal upper surface, and the upper surface is provided with, for example, a suction port (not shown) which sucks the wafer W. Suction through the suction port allows the wafer W to be suction-held on the spin chuck 20.

The spin chuck 20 has a chuck drive mechanism 21 equipped with, for example, a motor or the like and can be rotated at a predetermined speed by the chuck drive mechanism 21. Further, the chuck drive mechanism 21 is provided with a raising and lowering drive source such as a cylinder so that the spin chuck 20 is vertically movable.

Around the spin chuck 20, a cup 22 is provided which receives and collects liquid splashing or dropping from the wafer W. A drain pipe 23 for draining the collected liquid and an exhaust pipe 24 for exhausting the atmosphere in the cup 22 are connected to the bottom surface of the cup 22.

As shown in FIG. 2, on the side of the negative direction in an X-direction (the lower direction in FIG. 2) of the cup 22, a rail 30 is formed which extends along a Y-direction (the right-to-left direction in FIG. 2). The rail 30 is formed, for example, from the outside on the negative direction side in the Y-direction of the cup 22 (the left direction in FIG. 2) to the outside on the positive direction side in the Y-direction (the right direction in FIG. 2). To the rail 30, for example, two arms 31 and 32 are attached.

On the first arm 31, a coating solution nozzle 33 which supplies the coating solution is supported as shown in FIG. 1 and FIG. 2. The first arm 31 is movable on the rail 30 by means of a nozzle drive unit 34 shown in FIG. 2. This allows the coating solution nozzle 33 to move from a waiting section 35 provided at the outside on the positive direction side in the Y-direction of the cup 22 to a position above a central portion of the wafer W in the cup 22 and further move in a direction of the diameter of the wafer W above the wafer W. The first arm 31 freely rises and lowers by means of the nozzle drive unit 34 to be able to adjust the height of the coating solution nozzle 33.

To the coating solution nozzle 33, a supply pipe 37 communicating with a coating solution supply source 36 is connected as shown in FIG. 1. In the coating solution supply source 36, the coating solution is stored. The supply pipe 37 is provided with a supply equipment group 38 including a valve for controlling the flow of the coating solution, a flow regulator and so on.

On the second arm 32, a pure water nozzle 40 is supported which supplies a solvent for the coating solution, for example, pure water. The second arm 32 is movable on the rail 30 by means of a nozzle drive unit 41 shown in FIG. 2 and can move the pure water nozzle 40 from a waiting section 42 provided at the outside on the negative direction side in the Y-direction of the cup 22 to the position above the central portion of the wafer W in the cup 22. The second arm 32 freely rises and lowers by means of the nozzle drive unit 41 to be able to adjust the height of the pure water nozzle 40.

To the pure water nozzle 40, a supply pipe 44 communicating with a pure water supply source 43 is connected as shown in FIG. 1. In the pure water supply source 43, pure water is stored. The supply pipe 44 is provided with a supply equipment group 45 including a valve for controlling the flow of the pure water, a flow regulator and so on. Note that though the coating solution nozzle 33 for supplying the coating solution and the pure water nozzle 40 for supplying the pure water are supported on separate arms in the above configuration, they may be supported on the same arm, and movement and supply timings of the coating solution nozzle 33 and the pure water nozzle 40 may be controlled by control of the movement of the arm.

The operations of a drive system such as the above-described rotation operation and vertical operation of the spin chuck 20, the movement operation of the coating solution nozzle 33 by the nozzle drive unit 34, the supply operation of the coating solution of the coating solution nozzle 33 by the supply equipment group 38, the movement operation of the pure water nozzle 40 by the nozzle drive unit 41, the supply operation of the pure water of the pure water nozzle 40 by the supply equipment group 45 and so on are controlled by a control unit 50. The control unit 50 is composed of, for example, a computer including a CPU and a memory and can realize the resist coating treatment in the coating treatment apparatus 1, for example, by executing programs stored in the memory. Note that various programs used to realize the resist coating treatment in the coating treatment apparatus 1 are ones which are recorded, for example, on a storage medium H such as a computer-readable hard disk (HD), flexible disk (FD), compact disk (CD), magneto-optical disk (MO), or a memory card, and installed from the storage medium H into the control unit 50.

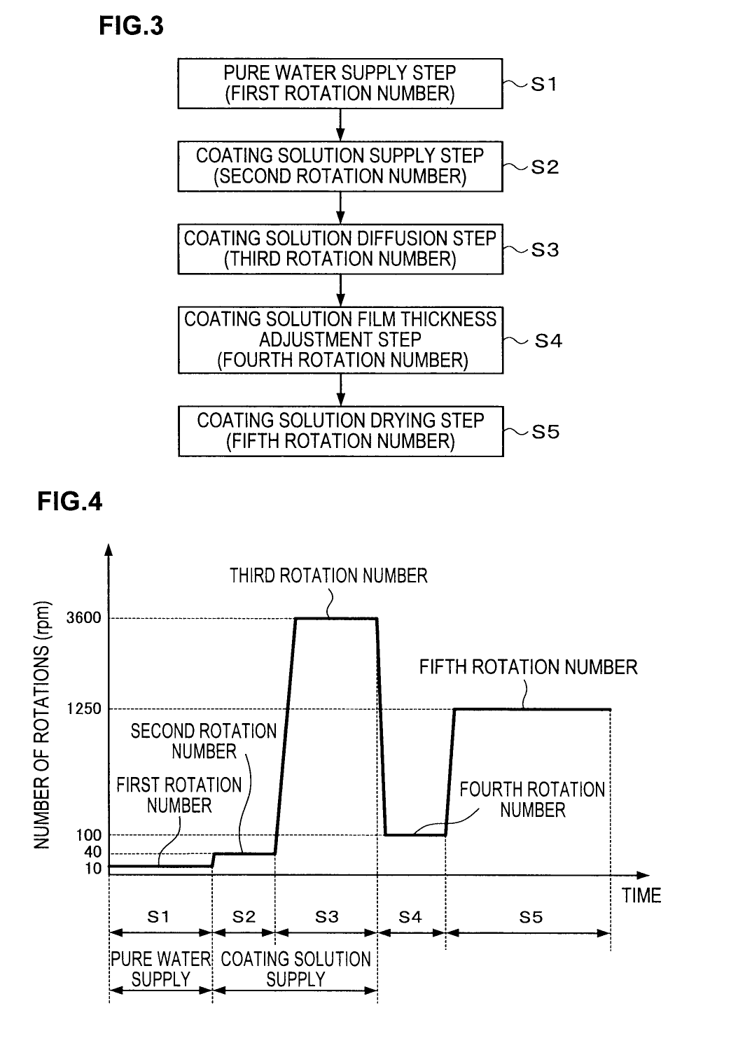

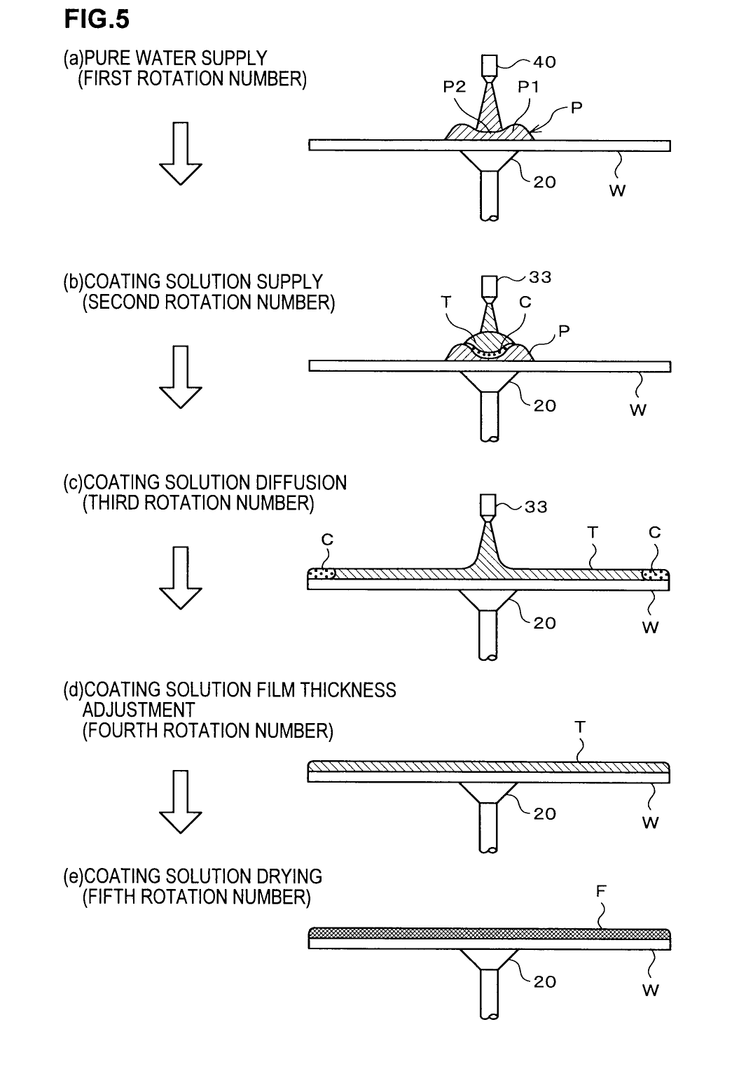

Next, the process of the coating treatment performed in the coating treatment apparatus 1 configured as described above will be described. FIG. 3 is a flowchart showing main steps of the coating treatment process in coating treatment apparatus 1. FIG. 4 is a graph showing the numbers of rotations (rpm) of the wafer W and the supply timings of the coating solution and the pure water in the steps of the coating treatment process. FIG. 5 schematically shows the state of a solution film on the wafer in each of the steps of the coating treatment process. Note that the length of time of the process in FIG. 4 does not necessarily correspond to the actual length of time for easy understanding of technique. Further, the resist film which has been formed on the wafer in advance is not shown in FIG. 5.

The wafer W transferred in the coating treatment apparatus 1 is first suction-held on the spin chuck 20. Subsequently, the pure water nozzle 40 at the waiting section 42 is moved by the second arm 32 to the position above the central portion of the wafer W. Then, the chuck drive mechanism 21 is controlled as shown in FIG. 4 to cause the spin chuck 20 to rotate the wafer W, for example, at 1 rpm to 30 rpm that is a first rotation number, 10 rpm in this embodiment. Concurrently with the rotation of the wafer W, a pure water P is supplied from the pure water nozzle 40 to the central portion of the wafer W as shown in FIG. 5(a) (Step S1 in FIG. 3 and FIG. 4). In the case where the wafer W is rotated at a low speed at the first rotation number as described above, the pure water P supplied on the wafer W hardly diffuses over the wafer W. Further, the rotation at the low speed exerts the centrifugal force on the pure water P, whereby a peripheral portion P1 of the pure water P is higher than a central portion P2 such that the central portion P2 of the surface of the pure water P becomes concave downward. Note that the Step S1 is performed, for example, for 4 seconds.

After the supply of the pure water P is finished, the pure water nozzle 40 is moved from the position above the central portion of the wafer W, and the coating solution nozzle 33 at the waiting section 35 is moved by the first arm 31 to the position above the central portion of the wafer W.

Subsequently, the rotation of the wafer W is accelerated, for example, to 30 rpm to 100 rpm that is a second rotation number, 40 rpm in this embodiment, and thereafter the wafer W is rotated at the second rotation number as shown in FIG. 4. Concurrently with the acceleration of the rotation of the wafer W, a coating solution T is supplied from the coating solution nozzle 33 to the central portion P2 of the pure water P as shown in FIG. 5(b) (Step S2 in FIG. 3 and FIG. 4). When the wafer W is rotated at a low speed at the second rotation number as described above, the pure water P hardly diffuses over the wafer W. Further, a mixed layer C in which the coating solution T and the pure water P are mixed together is formed under the coating solution T. Note that the Step S2 is performed, for example, for 0.5 seconds.

After the mixed layer C is formed under the coating solution T, the rotation of the wafer W is accelerated, for example, to 2000 rpm to 4000 rpm that is a third rotation number, 3600 rpm in this embodiment, and thereafter the wafer W is rotated at the third rotation number as shown in FIG. 4. In this event, the coating solution T is continuously supplied from the coating solution nozzle 33 as shown in FIG. 5(c). When the wafer W is rotated at a high speed at the third rotation number as described above, the mixed layer C diffuses over the wafer W, and the coating solution T is led by the mixed layer C and diffuses over the wafer W (Step S3 in FIG. 3 and FIG. 4). The mixed layer C is smaller in contact angle and better in wettability than the pure water P, so that the coating solution T can smoothly and uniformly diffuse over the entire surface of the wafer W. Note that the Step S3 is performed, for example, for 1.1 seconds.

After the coating solution diffuses over the entire surface of the wafer W, the rotation of the wafer W is decelerated, for example, to 100 rpm that is a fourth rotation number as shown in FIG. 4. During the rotation of the wafer W at the fourth rotation number as described above, a force directing to the center is exerted on the coating solution T on the wafer W, whereby the film thickness of the coating solution T on the wafer W is adjusted as shown in FIG. 5(d) (Step S4 in FIG. 3 and FIG. 4). This Step S4 is performed, for example, for 1 second.

After the film thickness of the coating solution T on the wafer W is adjusted, the rotation of the wafer W is accelerated, for example, to 1250 rpm that is a fifth rotation number as shown in FIG. 4. During the rotation of the wafer W at the fifth rotation number as described above, the coating solution T diffused over the entire surface of the wafer W is dried as shown in FIG. 5(e), whereby a coating film F is formed (Step S5 in FIG. 3 and FIG. 4). Note that the Step S5 is performed, for example, for 18 seconds.

According to the above embodiment, since the wafer W is rotated at the low speed at the first rotation number and the pure water P is supplied onto the rotated wafer W, the pure water P does not diffuse over the wafer W so that the front surface of the pure water P can be concaved downward. This ensures that when the wafer W is then rotated at the second rotation number and the coating solution T is supplied to the central portion P2 of the pure water P, the coating solution T never flows out from the top of the pure water P. Further, since the wafer W is rotated at the second rotation number and the coating solution T is supplied to the central portion P2 of the pure water P, the mixed layer C of the coating solution T and the pure water P can be formed under the coating solution T. This makes the mixed layer C smaller in contact angle and better in wettability than the pure water P, thus ensuring that when the wafer W is then rotated at the high speed at the third rotation number, the coating solution T is led by the mixed layer C and can smoothly and uniformly diffuse over the entire surface of the wafer W. Accordingly, the coating solution T can be uniformly applied within the wafer W and the supply amount of the coating solution T can also be reduced.

In the above-described embodiment, since the wafer W is rotated at the low speed at the fourth rotation number after the coating solution T diffuses over the entire surface of the wafer W, the force directing to the center is exerted on the coating solution T on the wafer W, whereby the film thickness of the coating solution T can be adjusted.

A preferred embodiment of the present invention has been described above with reference to the accompanying drawings, but the present invention is not limited to the embodiment. It should be understood that various changes and modifications are readily apparent to those skilled in the art within the spirit as set forth in claims, and those should also be covered by the technical scope of the present invention. The present invention is not limited to this example but can take various forms. For example, while the above-described embodiment has been described taking the coating solution to form the anti-reflection film as the water-soluble coating solution as an example, the present invention is also applicable to a resist pattern dimension shrinking agent (RELACS agent) in RELACS (Resolution Enhancement Lithography Assisted by Chemical Shrink) technique. Further, though the coating treatment is performed on the wafer in the above-described embodiment, the present invention is also applicable to the coating treatment for substrates other than the wafer, such as an FPD (Flat Panel Display), a mask reticle for a photomask and the like.

Hereinafter, in a more concrete example in which the coating solution is applied onto the wafer, the uniformity of the film thickness of the coating film formed on the wafer after the coating treatment will be described. Note that the coating treatment apparatus 1 shown in FIG. 1 and FIG. 2 was used as a coating treatment apparatus for performing the coating treatment on the wafer W. Further, the recipe of the timings to supply the coating solution T and the pure water P, the number of rotations of the wafer W or the like is the same as the recipe previously shown in FIG. 4.

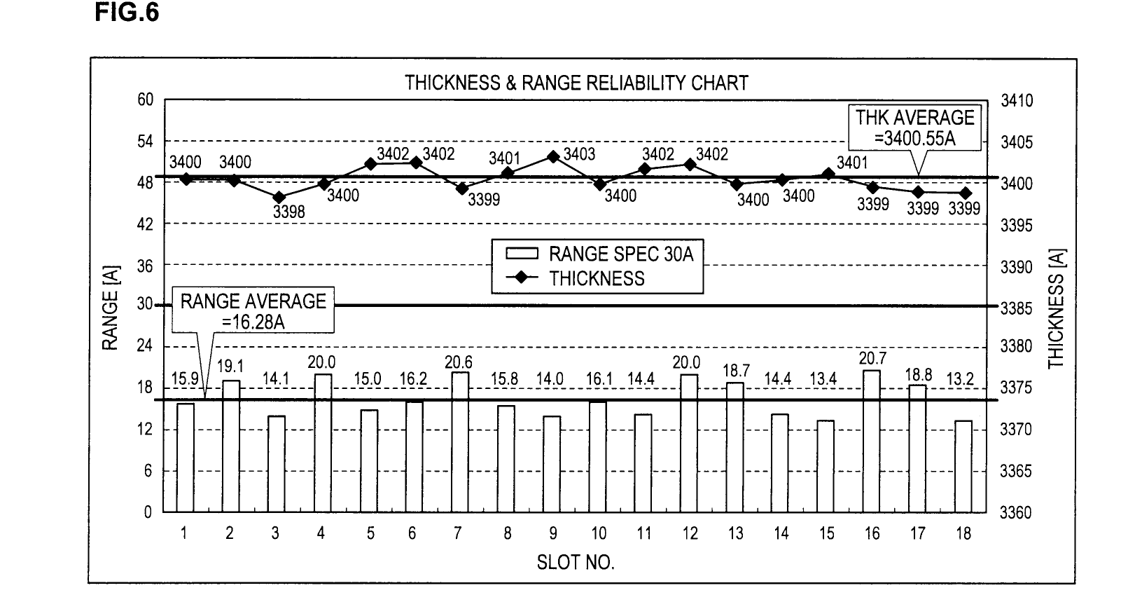

Under such conditions, the target film thickness of the coating film F to be formed on the wafer W after the coating treatment was set to 3400 Å, and the coating treatment was performed on 18 wafers W with the same recipe in the coating treatment apparatus 1. The result is shown in FIG. 6. The horizontal axis in FIG. 6 indicates the numbers of the wafers W in order, the number being given to the 18 treated wafers W in treatment order. The “Thickness” (the vertical axis on the right side in FIG. 6) at the vertical axis in FIG. 6 indicates the average film thickness within the wafer W of the coating film F formed on the wafer W, and the “Range” (the vertical axis on the left side in FIG. 6) indicates the difference between the maximum film thickness and the minimum film thickness of the coating film F within the wafer W.

As shown in FIG. 6, it was found that when the coating treatment method of the present invention was used, the average value of the average film thickness “Thickness” of the coating film F was 3400.55 Å and the coating film F can be formed in substantially the same film thickness as the target film thickness. Further, it was found that the average of the difference between the maximum film thickness and the minimum film thickness “Average” of the coating film F was as small as 16.28 Å and the coating solution T can be uniformly applied within the wafer W.

The supply amount of the coating solution T supplied to the wafer W when performing this example was 1.0 cc. On the other hand, from the check by the inventors, it was found that when the coating solution T was applied by the conventional coating treatment method proposed in Patent Document 1, the supply amount of the coating solution required for uniformly applying the coating solution T within the wafer W was 2.5 cc. Accordingly, it was found that when the coating treatment method of the present invention is used, the supply amount of the coating solution T can be considerably reduced.

The present invention is useful for applying a water-soluble coating solution onto a substrate such as a semiconductor wafer or the like.

What is claimed is:

1. A coating treatment method of applying a water-soluble coating solution onto a substrate, comprising:
a first step of supplying pure water to a central portion of the substrate in a manner that the pure water does not diffuse over an entire surface of the substrate;
a second step of subsequently supplying the water-soluble coating solution to a central portion of the pure water on the substrate to form a mixed layer of the coating solution and the pure water, under the coating solution; and
a third step of subsequently diffusing the mixed layer over the substrate to diffuse the coating solution over the entire surface of the substrate.

2. The coating treatment method as set forth in claim 1,
wherein in said first step, the substrate is rotated to concave a front surface of the pure water on the substrate downward to thereby make a peripheral portion of the pure water higher than the central portion.

3. The coating treatment method as set forth in claim 2,
wherein in said first step, the substrate is rotated at a first rotation number,
wherein in said second step, the rotation of the substrate is accelerated to a second rotation number higher than the first rotation number and the substrate is rotated at the second rotation number, and
wherein in said third step, the rotation of the substrate is accelerated to a third rotation number higher than the second rotation number and the substrate is rotated at the third rotation number.

4. The coating treatment method as set forth in claim 1,
wherein in said first step, the substrate is rotated at a first rotation number,
wherein in said second step, the rotation of the substrate is accelerated to a second rotation number higher than the first rotation number and the substrate is rotated at the second rotation number, and
wherein in said third step, the rotation of the substrate is accelerated to a third rotation number higher than the second rotation number and the substrate is rotated at the third rotation number.

5. The coating treatment method as set forth in claim 4, further comprising:
after said third step, a fourth step of decelerating the rotation of the substrate to a fourth rotation number lower than the third rotation number and rotating the substrate at the fourth rotation number to adjust a film thickness of the coating solution on the substrate to a predetermined film thickness; and
a fifth step of subsequently accelerating the rotation of the substrate to a fifth rotation number higher than the fourth rotation number and rotating the substrate at the fifth rotation number to dry the coating solution on the substrate.

6. A computer-readable storage medium storing a program running on a computer of a control unit which controls a coating treatment apparatus in order to cause the coating treatment apparatus to execute a coating treatment method,
said coating treatment method being a coating treatment method of applying a water-soluble coating solution onto a substrate, comprising:
a first step of supplying pure water to a central portion of the substrate in a manner that the pure water does not diffuse over an entire surface of the substrate;
a second step of subsequently supplying the water-soluble coating solution to a central portion of the pure water on the substrate to form a mixed layer of the coating solution and the pure water, under the coating solution; and
a third step of subsequently diffusing the mixed layer over the substrate to diffuse the coating solution over the entire surface of the substrate.

7. A coating treatment apparatus for applying a water-soluble coating solution onto a substrate, comprising:
a coating solution nozzle for supplying the coating solution to the substrate at a predetermined timing;
a pure water nozzle for supplying pure water to the substrate at a predetermined timing; and
a control unit,
wherein said control unit controls operations of at least said coating solution nozzle and said pure water nozzle to execute a first step of supplying pure water to a central portion of the substrate by said pure water nozzle in a manner that the pure water does not diffuse over an entire surface of the substrate; a second step of subsequently supplying the water-soluble coating solution to a central portion of the pure water on the substrate by said coating solution nozzle to form a mixed layer of the coating solution and the pure water, under the coating solution; and a third step of subsequently diffusing the mixed layer over the substrate to diffuse the coating solution over the entire surface of the substrate.

8. The coating treatment apparatus as set forth in claim 7, further comprising:
a rotating and holding unit for holding the substrate and rotating the substrate at a predetermined speed.

9. The coating treatment apparatus as set forth in claim 8,
wherein in said first step, said control unit controls an operation of said rotating and holding unit to rotate the substrate to concave a front surface of the pure water on the substrate downward to thereby make a peripheral portion of the pure water higher than the central portion.

10. The coating treatment apparatus as set forth in claim 9,
wherein said control unit controls the operation of said rotating and holding unit to rotate the substrate at a first rotation number in said first step, accelerate the rotation of the substrate to a second rotation number higher than the first rotation number and rotate the substrate at the second rotation number in said second step, and accelerate the rotation of the substrate to a third rotation number higher than the second rotation number and rotate the substrate at the third rotation number in said third step.

11. The coating treatment apparatus as set forth in claim 10,
wherein said control unit controls the operation of said rotating and holding unit to execute, after said third step, a fourth step of decelerating the rotation of the substrate to a fourth rotation number lower than the third rotation number and rotating the substrate at the fourth rotation number to adjust a film thickness of the coating solution on the substrate to a predetermined film thickness; and a fifth step of subsequently accelerating the rotation of the substrate to a fifth rotation number higher than the fourth rotation number and rotating the substrate at the fifth rotation number to dry the coating solution on the substrate.

12. The coating treatment apparatus as set forth in claim 8,
wherein said control unit controls the operation of said rotating and holding unit to rotate the substrate at a first rotation number in said first step, accelerate the rotation of the substrate to a second rotation number higher than the first rotation number and rotate the substrate at the second rotation number in said second step, and accelerate the rotation of the substrate to a third rotation number higher than the second rotation number and rotate the substrate at the third rotation number in said third step.

13. The coating treatment apparatus as set forth in claim 12,
wherein said control unit controls the operation of said rotating and holding unit to execute, after said third step, a fourth step of decelerating the rotation of the substrate to a fourth rotation number lower than the third rotation number and rotating the substrate at the fourth rotation number to adjust a film thickness of the coating solution on the substrate to a predetermined film thickness; and a fifth step of subsequently accelerating the rotation of the substrate to a fifth rotation number higher than the fourth rotation number and rotating the substrate at the fifth rotation number to dry the coating solution on the substrate.
